(19) United States
(12) Patent Application Publication
(10) Pub. No.: US 2007/0050285 A1
(43) Pub. Date: Mar. 1, 2007

(54) Interactive loan information importing and editing web-based system

(75) Inventor: Cheryl Lynn Freeman, McLean, VA (US)

Correspondence Address: FLESHNER & KIM, LLP, P.O. BOX 221200, CHANTILLY, VA, 20153, US

(73) Assignee: INFOTRAK INC.

(21) Appl. No.: 11/211,738

(22) Filed: Aug. 26, 2005

(51) Int. Cl. G06Q 40/00

(52) U.S. Cl. 705/38

(57) ABSTRACT

An interactive information management system generates a hierarchy of web pages for allowing mortgage brokers, lenders, and/or other personnel to track and manage each stage of the process of acquiring a mortgage. One web page includes a database search capability which is performed based on one or more user-specified criteria. Other pages provide more detailed information of loan records produced by the search. These pages serve as a useful tool in improving the efficiency of the mortgage acquisition process. They also help mortgage brokers better manage their accounts. The system also generates a qualifier sheet which allows different loan products to be compared. This additional functionality allows the system to further serve as a marketing tool locating the best financing options for borrowers.

### BACKGROUND OF THE INVENTION

1. Field of the Invention

The present invention generally relates to information management, and more particularly to systems and methods for managing information and providing services related to mortgages.

2. Background of the Invention

Advances in information technology have had a changing influence in many professional and private endeavors. In a typical day, stock trades are processed on-line, prescriptions are ordered by e-mail, merchandise is electronically auctioned, and bills are paid using a home computer.

In spite of these advances, many financial transactions are still mostly manually performed and paper based. And, to the extent that a computer is involved, its use is limited to data entry or other mundane functions. The reason for this lack of modernization is largely attributable to the complexities of the transactions themselves. Mortgage transactions, for example, require information to be pulled from a variety of independent sources. Then, financing and numerous loan approval procedures must be performed, requiring the expertise of individuals with diverse skill sets.

Presently, there exists no information management system that is commonly accessible to the various personnel involved in a mortgage transaction. There is also no system or method which electronically integrates all phases of the process of obtaining a mortgage within a single management structure. Other drawbacks of existing methods are also evident.

For example, conventional methods of providing mortgage services do not automate the process of evaluating products from lenders for clients, nor do they consolidate or coordinate the approval process or manage archived records of post-closing loan information. They also do not manage, monitor, and then interrelate the actions of third parties who play vital roles in securing final loan approval, nor do they allow the responsibilities of officers and other loan personnel to be automatically scheduled and tracked. Without the ability to perform these and other functions electronically, all the inefficiencies associated with conventional mortgage loan processing methods will continue to persist.

### SUMMARY OF THE INVENTION

An object of the invention is to provide a system and method of managing mortgage-related information in a way that represents an improvement over conventional methods.

Another object of the invention is to achieve the aforementioned object by electronically integrating the various components of the mortgage loan approval process into a single management structure.

Another object of the present invention is to provide a system and method of the aforementioned type using an interactive web site accessible by various personnel including persons who play a supporting role or are considered to be third-party providers, persons who are participants to the approval process, or the even clients or customers.

Another object of the present invention is to provide a system and method of the aforementioned type which is practiced using a hierarchy of web pages, each performing one or more dedicated management and tracking functions in the loan origination, acquisition, underwriting, and approval process.

Another object of the present invention is to provide a system and method which automates the process of evaluating products from various lending sources for prospective client-borrowers.

Another object of the present invention is to provide a system and method which electronically generates a qualifier sheet for comparing different loan products during the loan origination process, which qualifier sheet may be used as a marketing tool for improving the efficiency and reliability of matching a particular or most suitable loan product.

Another object of the present invention is to provide a system and method which consolidates and/or coordinates information required to advance the mortgage loan approval process, and/or which manages archived records of previously closing loan information for future access by mortgage loan originators, for example, for marketing and/or historical purposes.

Another object of the present invention is to provide a system and method which serves as a tool for managing, monitoring, and interrelating the actions of third-party vendors or service providers who play vital roles in securing final loan approval.

Another object of the present invention is to provide a system and method which tracks and coordinates the flow of responsibilities between loan officers and other loan personnel such as but not limited to processors, underwriters, closers, and/or managers.

These and other objects and advantages are achieved by providing an interactive information management system, comprising a communications port, a database to store information relating to a plurality of mortgages, and a system processor coupled to the communications port for generating a web page. The web page preferably includes a first section for allowing a user to designate one or more criteria relating the mortgage information stored in the database, and a second section for displaying results of a database search performed by the processor based on the designated search criteria. The search results include information identifying one or more matching loan records.

The first section may include a number of fields or windows for allowing a user to designate the search criteria. These fields allow a user to designate, for example, how the search results should be sorted for display in the second section, the name of a mortgage specialist responsible for performing a next step in managing a mortgage specified in the second section, as well as other information directly related to the specific details of the loan. A field may also be included to allow a supervisor to assign management of a mortgage specified in the second section to a particular specialist in a loan originator's office.

The web page may additionally include a task scheduler function performed by the processor. This function may notify a mortgage specialist of mortgages that have been assigned to him or her on any given day. The scheduler function is preferably implemented through one or more fields in the first section which allow a user to designate said criteria for performing the database search.

The second section of the web page may include selectable icons associated with the loan records identified by the search results. Each of the selectable icons are linked to at least one additional web page that provides additional information relating to a corresponding one of the loans records identified in the second section. The second section may also provide for each loan record information indicating a corresponding loan number, a borrower/co-borrower, a closing date if applicable, a mortgage specialist responsible for managing the associated loan, loan status, and a loan type.

In accordance with an especially advantageous feature, the invention provides password-protected access to the web page by all parties involved in the mortgage acquisition and management process. These parties may include, for example, at least one loan originator, at least one lender, one or more third-party agents, and/or the clients or customers themselves. An interactive information management method may generate a web page of this type using the system disclosed herein.

### BRIEF DESCRIPTION OF THE DRAWINGS

FIG. 1A is a diagram showing one possible implementation of an interactive management system in accordance with the present invention, and FIG. 1B is a diagram showing another possible implementation of this system.

FIG. 2 shows one possible hierarchy of web pages that may be generated in accordance with the method of the present invention.

FIG. 3 shows an example of a first-tier web page that may be generated by the system and method of the present invention.

FIG. 4A shows one type of second-tier web page that may be accessed by selecting a loan record displayed in the first-tier web page;

FIG. 4B shows another second-tier web page generated in accordance with the present invention;

FIG. 4C shows another second-tier web page generated in accordance with the present invention;

FIG. 4D shows another second-tier web page generated in accordance with the present invention;

FIG. 4E shows another second-tier web page generated in accordance with the present invention;

FIG. 5A shows a detailed example of a web page corresponding to FIG. 4A that may be generated for a basic information tab selected in accordance with the present invention;

FIG. 5B shows a detailed example of a web page corresponding to FIG. 4B that merges the display of multiple loans used to secure financing of a property, which page is generated when a Program Rate Information tab is selected in accordance with the present invention;

FIG. 5C shows a detailed example of a web page corresponding to FIG. 4C that may be generated when the agents tab is selected in accordance with the present invention;

FIG. 5D shows a detailed example of a web page corresponding to FIG. 4D that may be generated when an internal action items tab is selected in accordance with the present invention;

FIG. 5E shows a detailed example of a web page corresponding to FIG. 4E that may be generated when a financial information tab is selected in accordance with the present invention;

FIGS. 6A-6C shows different pages of an exemplary qualifier sheet generated in accordance with the present invention;

FIG. 7 shows an example of a web page generated in connection with an underwriting program performed in accordance with the present invention.

### DETAILED DESCRIPTION OF EMBODIMENTS

The present invention is, in one embodiment, an interactive system and method which manages information by performing functions that include monitoring, tracking, processing, and/or marketing information relating to financial instruments. In other embodiments, the present invention is a system and method which may be used as a tool for managing and implementing financial services. In other embodiments, the present invention is an interactive tool that associates within a single management structure varying financial or investment-related products, preferably in comparative format, for consideration by customers or prospective customers. The financial instruments or products managed by these embodiments are preferably related to mortgages, although other forms of debt such as but not limited to home-equity loans and debentures may also be managed.

The embodiments of the invention are preferably interactively implemented through one or a series of interrelated web pages. One web page may include, for example, a list of the mortgage loans that are currently being managed by a loan originator along with associated information relating to the loan. This information may be displayed in varying hierarchical formats, in one or more predefined windows or fields, as a spreadsheet, or a combination thereof.

In addition to information relating to borrowers (e.g., names, phone numbers, e-mail addresses, etc.), the web page may include information regarding other aspects of the loan such as but not limited to loan number, closing date, loan status, and/or associated loan originator representative information. A search function may also be included to allow information to be displayed and sorted on the web page based on user-defined search criteria. This criteria may include one or more of loan number, borrower name, closing date, or other information to be described in greater detail below.

The web page may also allow users to provide notes and/or reminders relating to particular mortgage loans. These notes/reminders may relate, for example, to deadlines for loans, the date a call back to the borrower is necessary, and/or other information. The web page also preferably includes a hyperlink for each mortgage loan, which hyperlink can provide access to one or more additional web pages that provide more detailed loan information.

The additional web page for each mortgage may display more detailed information concerning a selected loan, as well as information that will allow management to instantly determine the stage of loan processing and the outstanding requirements yet to be performed prior to closing. Examples include program rate information, third party agents, internal action items, and financial information. The additional pages, which may be displayed in a hierarchical order, may also allow for the import or export of information from/to one or more persons or system programs associated with the loan approval/management process. Additionally, through the web pages of the invention, mortgage loan application information may be electronically transferred to or received from lenders, clients, agents or third parties.

From a user standpoint, the system and method of the present invention are suitable for use by loan originators, who interact with one or more lenders each offering different loan programs (often called “products”) to the public. The invention may also be used by the lenders themselves or any other party considered to be a participant in the loan acquisition and management process.

The management system and method may also serve as an effective tool for allowing loan originators to more effectively meet the needs of prospective borrowers. For example, the invention may help borrowers navigate through the loan application process or identify loan products that best fit their needs. These benefits may be illustrated by the following comparison.

Different lenders have different requirements and some products can have conditions that some borrowers can meet but others cannot. Alternatively, conditions can be met through higher fees (e.g., points) or interest rates. Traditionally, the loan originator would manually review loan products from multiple lenders and then try to select the one or two products that match the borrower's preferences or financial situation. When performed manually, the review process can be a time consuming task, especially when the terms and conditions of the products and/or their availability are subject to change. The interactive management system and method of the present invention automates the task of the loan originator, thereby making the process more efficient and enabling him to more effectively meet the needs of the client-borrower.

### System Overview

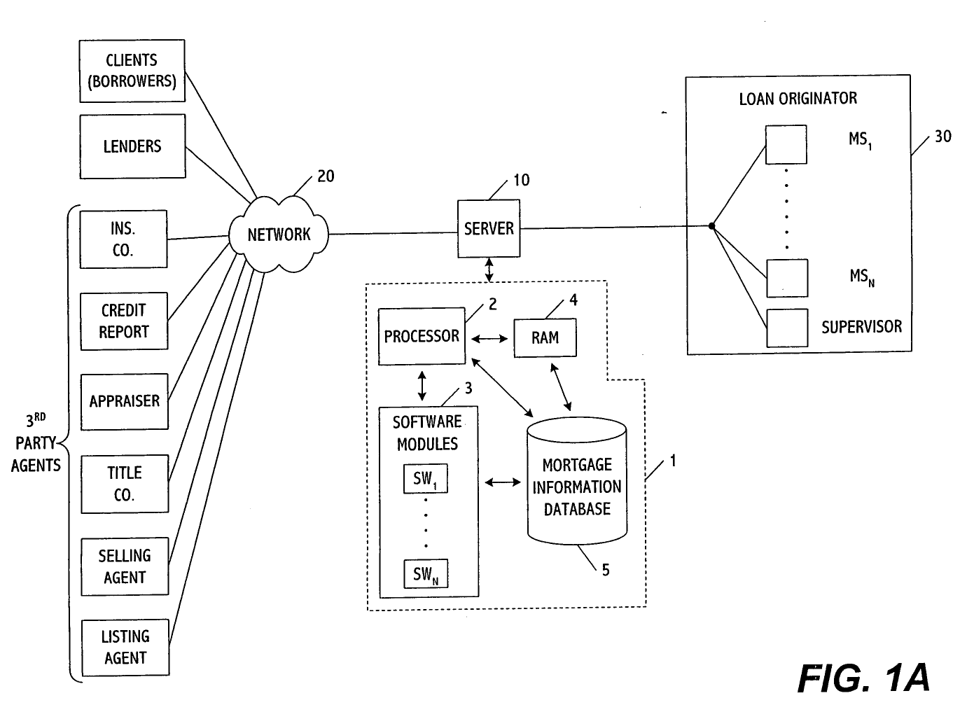

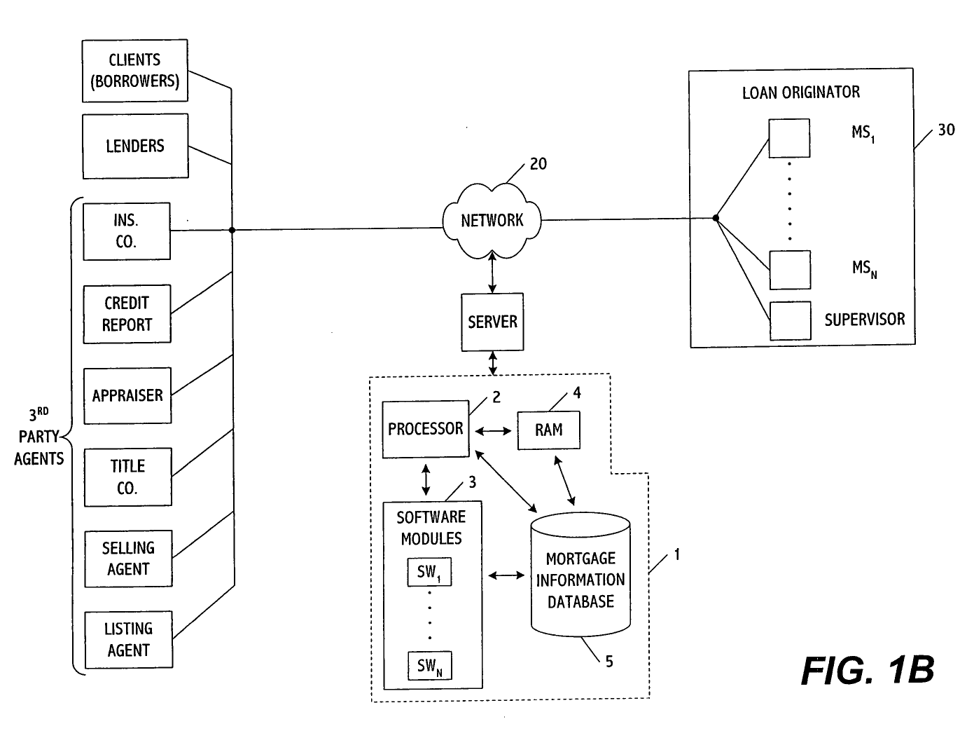

FIG. 1A is a conceptual diagram showing one possible implementation of an interactive management system 1 in accordance with the present invention. The system includes a central processor 2, a bank of software modules 3, a memory 4, and a database 5. The processor may be any type of computer or processing unit although a personal computer may be expected to be used in a typical application.

The software modules are preferably programs written to perform specific functions within the management system. For example, one program may be called by the processor to perform a mortgage underwriting function. Another program may be used to import or export data. Another program may be used to merge information from different database records or external sources. Another program may perform tracking or monitoring or other functions of the management system. The programs may be stored in a separate storage device, memory 4, or an internal memory of the processor.

The database stores mortgage information to be interactively managed by the system processor. This information includes records containing personal, financial, and other forms of data relating to properties managed, for example, by a loan originator. The processor retrieves, overwrites, computes, and manipulates information from the database in response to commands from loan originator employees and/or other parties, including lenders, borrowers, or anyone else involved in the mortgage loan application, processing, and approval process.

The database information may be manually entered at a workstation or imported from an external source. Examples of imported information include rate information, application forms from lenders, financial information, qualifying information, credit reports, appraisal information, title report, and information required for mortgage underwriting, just to name a few. The database information may also be exported to external sources in response to user commands, or may be exported to other application programs (e.g., Excel for spreadsheet and report generation) executed by the processor.

The mortgage information may relate to any type of real estate. In one application, the database stores information relating to one or more of residential property (e.g., single family detached, townhouses, condos, etc.), commercial property, and land as well as investment property and vacation homes. The property may be purchased or subject to refinancing.

Also, for each property, financial data is stored including associated loans and debt instruments, personal data of the borrower/co-borrower required for qualification, and information required for loan approval. For example, if the property is subject to a single mortgage, database records may be stored to provide all details of interest associated with the mortgage. According to an especially advantageous embodiment of the invention, if financing for the property is secured through multiple loans, the database stores all information of interest associated with those loans. The information for these loans may then be accessed by the system processor, merged, and subsequently displayed as a single form.

In this implementation, interactive management system 1 is coupled to (or included within) a server 10 situated between a communications network 20 and a loan originator's office 30. The server performs a variety of functions either alone or with the assistance of the system processor. These functions include web page generation, network connection, and data transfer functions described in greater detail below.

The communications network may be any type of network including ones that are wire-line and/or wireless. To support secure intra-corporate management functions, the network may be a WAN or virtual private network. In a more common application, the network may include the Internet. On the opposite side, the server may be connected to an intranet, LAN, or other local network in the loan originator's office.

Office 30 may include a single workstation or a plurality of work stations MS₁ to MS_{N}, each used by a different mortgage specialist. In one office set-up, the specialists each have different tasks to perform in managing the loan application, processing, and approval process. For efficiency purposes, the system processor may advantageously perform a task scheduling and note generation function to better coordinate work flow among the specialists. The term “mortgage specialist” as used herein may include but is not limited to any one or more of loan processors, underwriters, personnel handling closings or post-closings, secondary personnel, and accounting personnel.

In terms of connectivity, the workstations may access the network through server 10, or the workstations may be connected to the network through another server. In this latter case, access may be established though a data path that passes through the Internet and terminates at server 10.

To streamline the management process, the system may be linked to a variety of third-party sites through the network. These parties include selling agents, listing agents, insurance company agents, a credit report agency, an appraiser, and the title company just to name a few. The system may also be linked to sites associated with the lenders themselves and/or to sites associated with the clients of the loan originator (e.g., borrowers and co-borrowers). The links between the system and these parties are preferably bidirectional to allow for the electronic exchange (e.g., downloading and uploading) of information. In this way the management system, including all or a portion of the mortgage information stored in the database, may be shared to improve the overall efficiency of the mortgage approval process. The import of information from third-parties is especially beneficial because it will allow for the generation of a set of software-based marketing tools.

One such tool includes the generation of a qualifier sheet which merges together, preferably in a side-by-side comparison, loan product information from a variety of lenders. A qualifier sheet of this type can then be sent to a prospective borrower for consideration. The details of this qualifier sheet will be discussed in greater detail.

FIG. 1B shows another possible implementation of the interactive management system of the present invention. In this implementation, the loan originator specialists access the server containing the system processor through the network. All other features may be similar to those shown in FIG. 1A.

### Web Page Generation

An interactive management method according to the present invention is preferably performed with the assistance of the system shown in FIG. 1A or 1B. In accordance with one embodiment, this is accomplished through the generation of one or more interactive web pages through which the management aspects of the method are implemented.

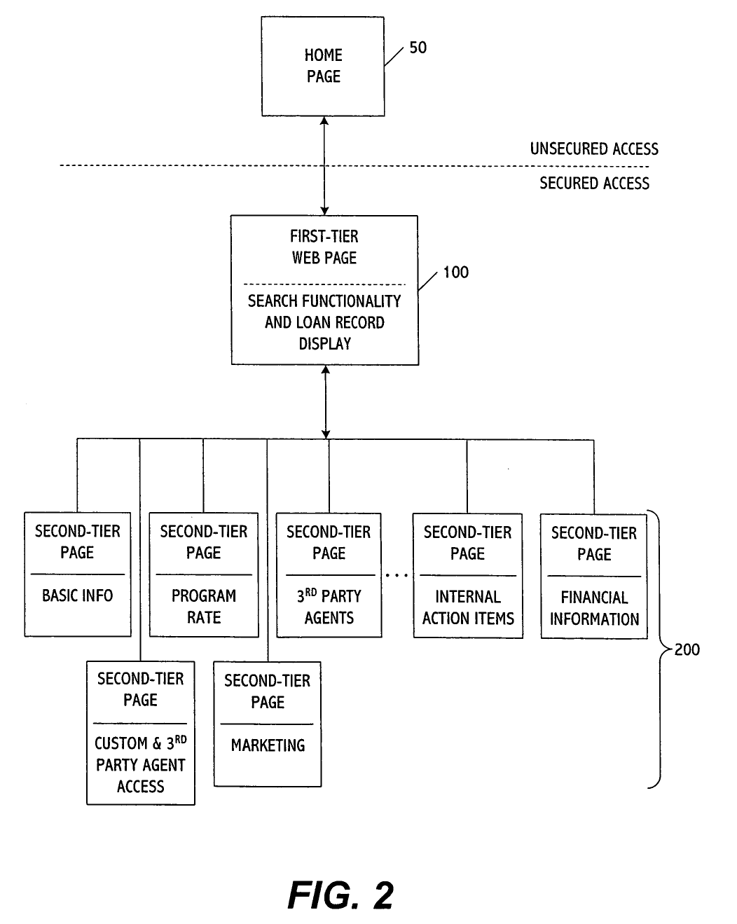

FIG. 2 shows one possible hierarchy of web pages that may be generated in accordance with the method of the present invention. Initially, when a user connects to a URL of the system server, a home page 50 is displayed. This home page may provide information relating to the managing entity, who, for example, may be a loan originator, a lender, or any other party associated with the loan acquisition/management process. The home page may also include a welcome message promotional and product information and links to additional web pages, which links may be password-protected.

The additional web pages preferably perform the management functions of the present invention. For example, a first web page 100 may perform mortgage database searches based on criteria designated by a user. This web page may also display the results of a search in any one of a number of predetermined or user-definable formats. A second tier of web pages 200 may be accessed through the first web page to perform, for example, a number of specialized management functions. These functions include mortgage loan underwriting, credit report review, loan tracking, approval monitoring, display of personal and financial information relating to properties or loans, as well as other functions.

### First-Tier Web Page

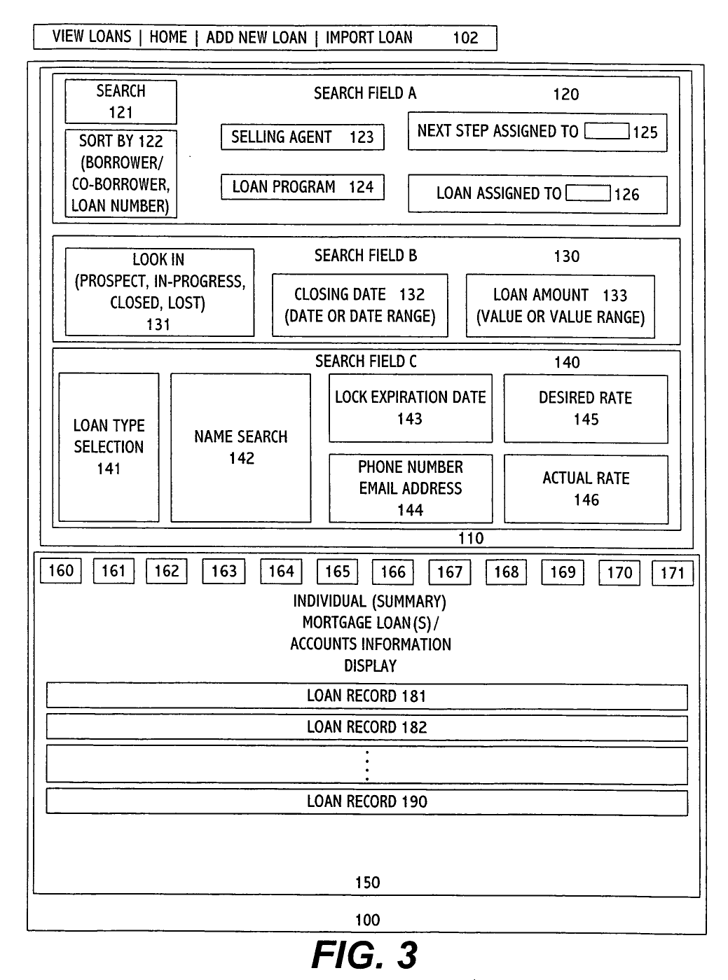

FIG. 3 shows an example of one type of web page 100 that may be generated by the system and method of the present invention. This web page includes a toolbar 102, a screen area 110 which enables a user to designate one or more criteria in searching for mortgage loan information stored in the database, and a screen area 150 for displaying the results of the search preferably in a predetermined order. This web page may be used by personnel as a main management page in accessing mortgage information of interest. The invention is particularly well suited to assisting mortgage specialists (e.g., employees or representatives of a loan originator), although other personnel may find the invention just as useful including but not limited to the types of third-party agents to be discussed.

The tool bar includes selectable icons which enable a user to perform one or more mortgage-related functions or services. One icon (“Add New Loan”) calls a program that enables a user to add a new loan record to the database. In accordance with one embodiment, by selecting this icon the program activates a wizard which requests the user to input information step-by-step until the new loan record is complete. The information may then be automatically entered into predefined fields of a displayed form corresponding to the record. Alternatively, the program may display the form with blank fields that are filled in by the user.

Another icon (“Import Loan”) calls a program that enables loan information prepared by an external agent (e.g., a lender when the loan originator and lender are separate entities) to be entered as a new record into the database. The program may be written to automatically enter relevant information into pre-defined fields of the record when electronically received from the external agent. Any number of well-known import software packages may be used for this purpose. Like the program associated with the new-loan icon, the program called by the import-loan icon may be implemented by a wizard to assist a user in the import procedure.

Screen area 110 enables a user to designate one or more criteria to locate mortgage information stored in the database. In the example shown, screen area 110 includes three categories of search criteria labeled Search Field A 120, Search Field B 130, and Search Field C 140.

Search Field A initially includes two windows 121 and 122 for respectively implementing a search based on information entered into one or more other windows and for designating a format of the results of the search. This latter window may include a drop-down menu which allows a user to specify whether the search results should be listed (in screen area 150), for example, by closing date, loan number, loan type, borrower, co-borrower, priority, and warnings. The results may be displayed in alphabetical or numerical order depending on the format selected.

Windows 123 and 124 allow a user to search the database for mortgage loans associated with a particular selling agent or a particular loan program, respectively. To assist the user, these windows may include drop-down menus containing predetermined lists of agent names and programs selectable by a cursor. Search Field A may also include two additional windows. These windows, 125 and 126, are particularly useful to the in-house processing of a loan application by the loan originator. Window 125 allows a user to determine which mortgage specialist (MS) in the loan originatorage house is charged with performing a certain step (or duty) in a series of steps required for processing a loan.

Consider, for example, a typical scenario where mortgage specialist #3 (an employee) wants to know what loans have been assigned to him for processing in any given day. To find out, MS #3 would enter his name into window 125 and perform a search. A list of loans will then be displayed in screen area 150. MS #3 would then perform the specific loan processing step or steps that he has been assigned. He could then update the database record to indicate the next employee (MS #4) charged with performing the next step in the process.

Window 125 is therefore considered to be an especially advantageous feature of the invention, because it allows the employees in a loan originator to determine what work responsibilities he or she may have on a daily basis. Window 125, thus, effectively operates as a task manager for the mortgage specialists in a loan originator. As an added benefit, this window may also be used by supervisors to determine and track the productivity of the loan originator employees.

Window 126 allows a user to search the database for loans assigned to particular mortgage specialist in the loan originator house. The information in windows 125 and 126 may be entered by directly typing in a name or by making an appropriate selection is a drop-down menu of pre-listed names.

Search Field B includes windows which allow a user to designate additional search criteria. Window 131 allows a user to search the database for loans that have a particular status, such as loans that are prospective (e.g., being considered by a customer-borrower but no lock-in has occurred yet), in progress, closed, or lost. Each of these categories may be associated with a separate selectable icon for search designation purposes.

Window 132 allows a user to search the database for loans based on specific closing date, or range of dates related to closing. The date information may, for example, be typed into this window, or drop-down menus may be provided to assist with entry of this information.

Window 133 allows a user to search for loans based on the amount (or principal) of the loan. Like window 132, this may also be performed based on a range of amounts either through manual data entry or drop-down menu.

Search Field C includes windows which allow a user to designate additional search criteria. Window 141 allows a user to search for loans based on loan type. This may be accomplished by selecting one or more icons that indicate, for example, that the loan(s) being searched for correspond to an initial loan on the purchase of property (“purchase”) or the re-financing of property. Both icons may be selected if desired.

Window 142 allows a user to search for loans associated with the name or nickname of the borrower, or the names of the borrower and co-borrower(s). This may be accomplished by entering last names and/or full names of the borrower and co-borrower.

Window 143 allows a user to search for loans associated with a particular lock-in expiration date, or a range of dates corresponding to a period when the lock-in was/is active.

Window 144 allows a user to search for loans associated with a particular telephone number or e-mail address of, for example, the borrower or co-borrower. A portion of the telephone number or e-mail address may also form the basis of a search in this window.

Window 145 allows a user to search for loans having a desired interest rate. This may be performed based on prospect loans, in-progress loans, closed loans, or even lost loans. Window 145 may also be used to search for loan products being offered by one or a collection of lenders. Information on these products may be imported from external sources (e.g., the respective web sites of the lenders) and stored in a memory. The memory may then be searched to locate mortgages that conform to the interest rate entered into window 145.

As rates drop or vary, window 145 may be further used to search the database for clients who are looking for a certain rate (or loan product). Once a conforming list is generated and displayed (e.g., in screen area 150), a mortgage specialist may contact the clients and say: “Hey, we know your looking for a X % rate on a Y type of loan, and it is now available.” Alternatively, the follow-up procedures can be directly or automatically generated (e.g., warnings, next step assigned to) by the system.

In at least these ways, the web page of the present invention may serve as an effective marketing tool in finding acceptable financing for prospective customers. (If desired, window 145 may include data entry fields for allowing a user to enter a range of interest rates.) As an additional feature, the web page may offer the capability of generating and sending thank notes, for example, to the customer and/or the referring party (e.g., selling agent).

Window 146 allows a user to search for loans having a particular interest rate. To broaden the search, this window may include data entry fields for allowing a user to enter a range of interest rates.

In performing a search, one or multiple criteria may be designated or otherwise specified within each of Search Fields A, B, and C. A minimum one criteria in at least one of these fields should be selected to ensure that an effective search is performed. The system processor will then search the loan information stored in the database and/or memory based on the designed criteria and display the results in screen area 150.

Screen area 150 sorts the search results based on the format specified in window 122. These results are preferably in the form of entries corresponding to loan records (illustratively labeled 181-190) produced by the search. In a preferred application of the invention, each loan record listed includes the following information arranged at positions which correspond to column headers 160-172.
Loan Number 161
Name(s) of Borrower(s) 162
Rate Lock-In Information 163
Closing Date 164
Identification of Mortgage Specialist Handling the Loan 165
Call Back Information 166
Phone Number(s) of Borrower, Lender, or other persons 167, 168
Loan Status 169
Loan Type 170
Warnings 171

Warnings may be letter codes or other symbols having a predefined or understood meaning. Exemplary warnings may correspond to requirements to be completed before the closing of a loan, the number of days to go before closing etc. As previously discussed, window 122 advantageously allows loan records to be searched and displayed (preferably in sorted order) based on impending closing dates and/or other types of warnings or matters associated with a loan. Through the first web page, the system of the present invention may therefore serve as a tracking tool for each mortgage specialist and concurrently as a management tool for allowing supervisors to monitor work efficiency and completion rate.

Based on the loan type or situation, it is understood that some of the information corresponding to the column headers identified above will not be included in each record. For example, for an in-progress loan, no information will as of yet be included in the Closing Date window. In addition to these headers, each loan record may be associated with an icon which, if selected, retrieves a second web page containing detailed information relating to that loan. This icon may be included at a position corresponding to header 160.

The first web page therefore serves as a tool which provides mortgage specialists (MS) the opportunity to access and display, in a user-specified format based on user-specified criteria, information corresponding to all the loans stored in the system database. In practice, this page allows mortgage specialists and other personnel to monitor, organize, and/or track loans and loan-procedure responsibilities by viewing system data.

To protect the integrity of the information stored in the database, the first web page (and indeed all subsequent web pages) are preferably password-protected, at least with respect to persons not directly employed by the loan originator. These persons may include, for example, other loan originators, lenders, clients, and third-party agents who perform any one of a number of loan-processing tasks. Employees of the loan originator may access the web page/system through an intranet, LAN, or other network connection.

### Second-Tier Web Pages

The first web page may be used to access one or more web pages to provide an enhanced level of system capability. Examples of these web pages will now be discussed.

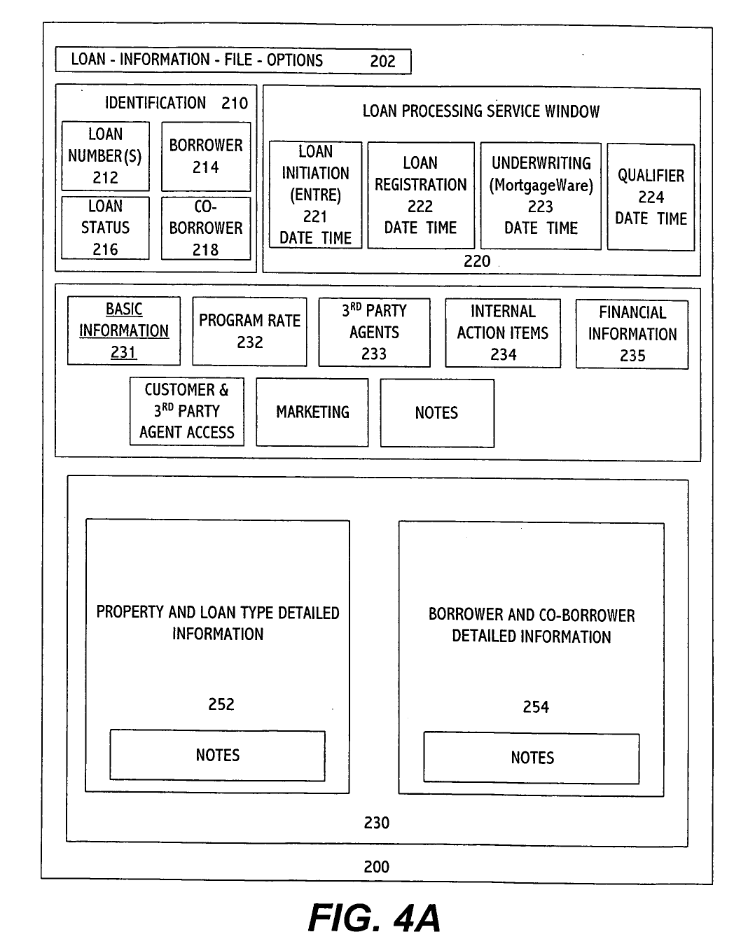

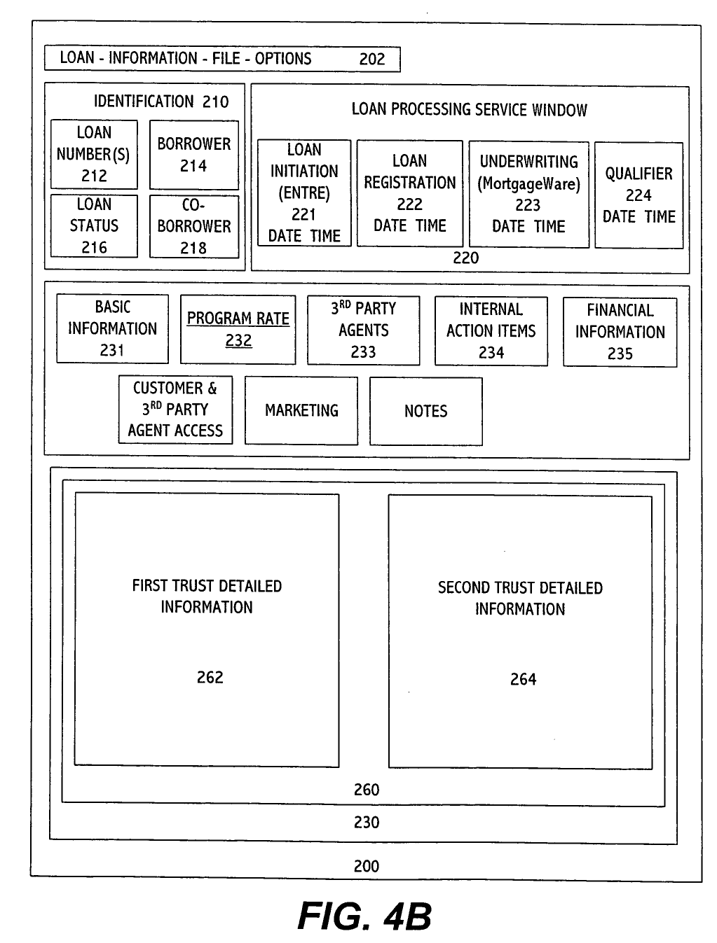

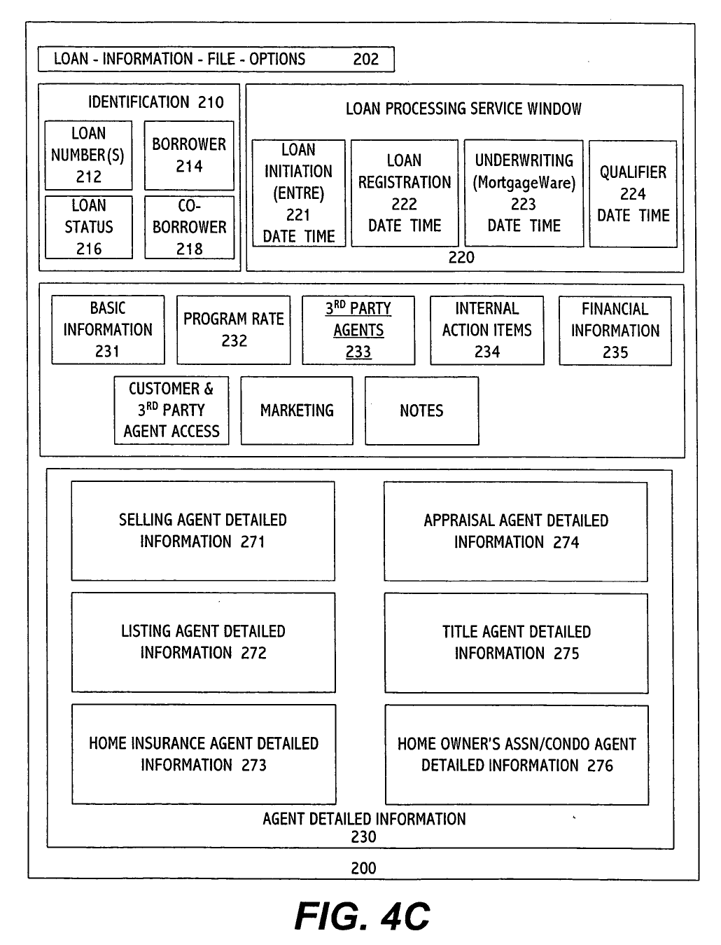

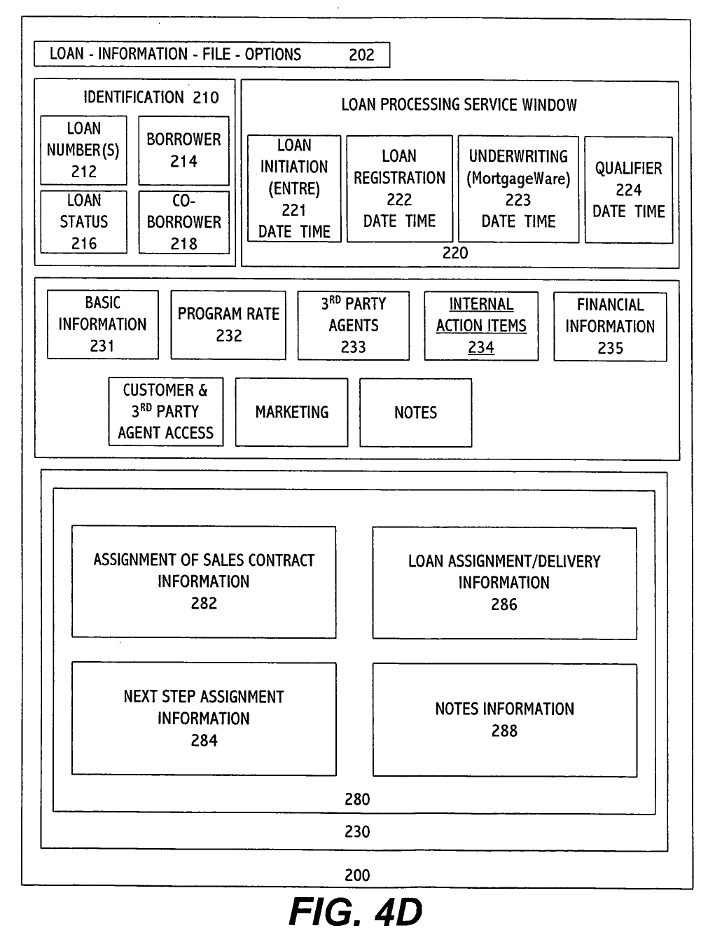

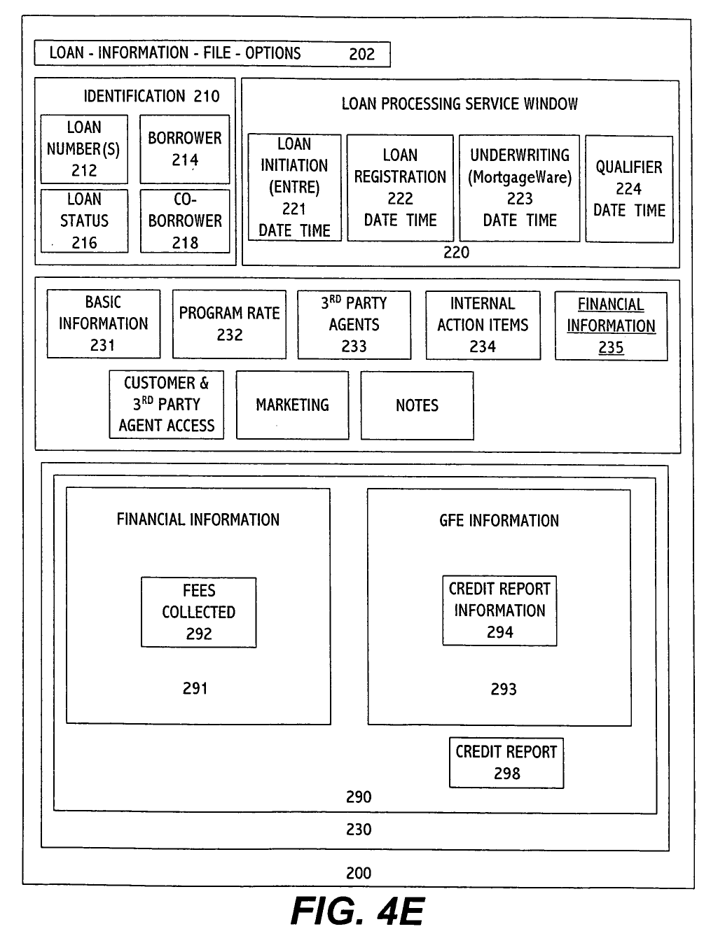

FIG. 4A shows a secondary web page 200 that may be generated for a corresponding a loan record selected in screen area 150 on the first web page. The selection may be made, for example, by clicking on the icon appearing in column 160 associated with the loan record.

This web page includes a tool bar 202, an identification window 210, a loan processing service window 220, and a detailed loan information window 230. The tool bar may include a selectable icon (“File”) that allows a user to save or delete the loan record or merge the information for this loan with another loan record. A merger may be performed, for example, to display a merged loan record containing first and second trust information on a single screen, discussed in greater detail below.

The tool bar may also include icons which, when selected, allow (1) information included in the loan record to be exported to another source program (e.g., Excel Spreadsheet) or party, (2) loan information to be imported from an external source such as but not limited to the website of a lender or one or more third-party agents, (3) access to a loan look-up sheet of available loans from particular lenders, (4) access to information indicating the terms and conditions of first or multiple loans (trusts) associated with the loan record, and (5) for generation of vCard associated with the loan. A vCard is a format that allows for contact information to be sent from a web site to Microsoft Outlook.

The identification window displays information, in field 212, including the number associated with the record selected in the first web page. This number may be the same number displayed in column header 161 of the selected record. This window may also identify the borrower in field 214, the status of the loan (e.g., in progress, closed, etc.) in field 216, and the co-borrower in field 218 if applicable.

The loan processing service window includes a window 221 (referred to as “Entre”) that provides a date and timestamp of when the mortgage corresponding to the loan record was initiated. A window 222 may also be included to provide a date and timestamp of when loan registration occurred. A window 223 may also be included to provide a date and timestamp of when the loan was underwritten. And, a window 224 may be included to provide a date and timestamp of when borrower qualified for the loan. As an alternative, the date and timestamp associated with these window may indicate the date and time when a last data import operation was performed in connection with their associated functions.

The loan processing service window also preferably includes a selectable icon which, when selected, accesses for display information pertaining to the underwriting conditions and terms of the loans. An example would provide this information in checklist form indicating whether an approval decision has been made, the reasons for disapproval if an adverse decision was made, the conditions that must be satisfied prior to settlement (e.g., homeowner's insurance, appraisal, price agreement, tax issues, MI approval, loan type, etc.), and conditions to be satisfied at settlement to name a few.

The detailed loan information window includes a number of selectable tabs for displaying different types of information in display area 230. A basic information tab 231 may be set as the default tab when web page 200 is initially displayed. The basic information display area may include a section 252 containing additional specific information concerning the mortgaged property and the type of mortgage secured, or sought to be secured. This additional information includes the type of property (primary residence, secondary residence, investment, etc.), loan type indicating purchase, re-finance, construction, permanent improvement, bridge, and/or stand-alone second trusts, property type such as townhouse, condominium, single family detached, land, etc., and address information. This section may also advantageously include a Notes section which allows mortgage specialists to enter in textual information that further explains the nature of the property and/or loan that may be considered useful by a loan originator, lender, or third-party agent in performing loan processing/acquisition/management functions. This section may also include credit report information and/or an icon which, when selected, retrieves copies of the borrower's and co-borrower's credit report stored in memory. Alternatively, the notes may be provided in a separate tab as shown, for example, in FIGS. 4A-4E.

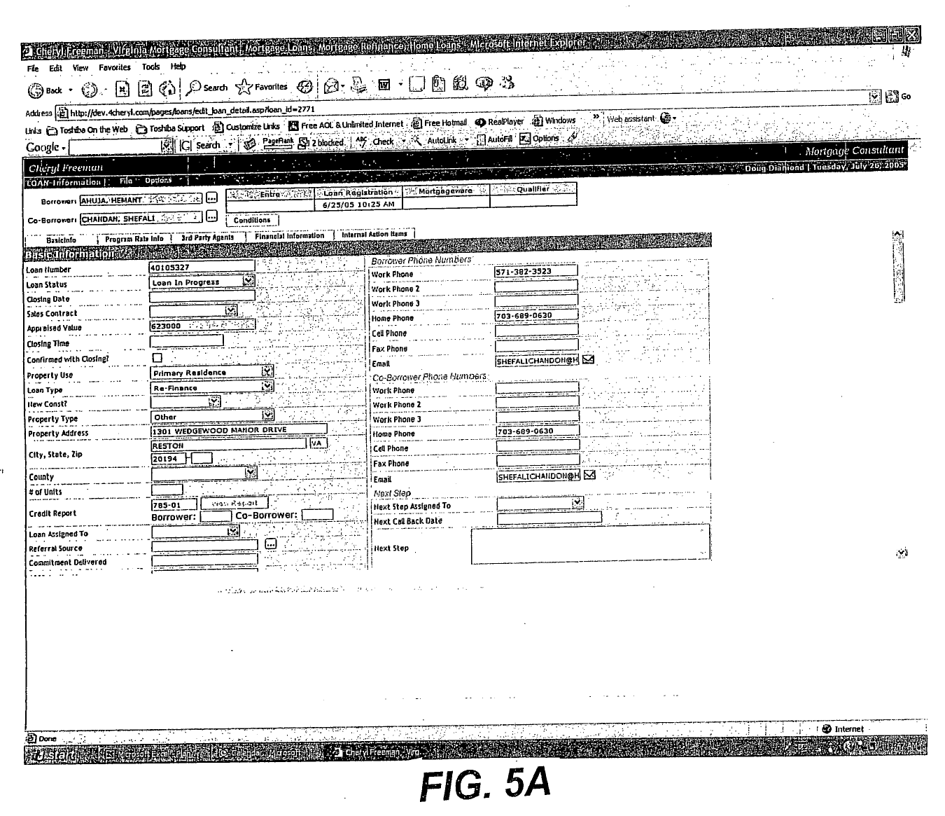

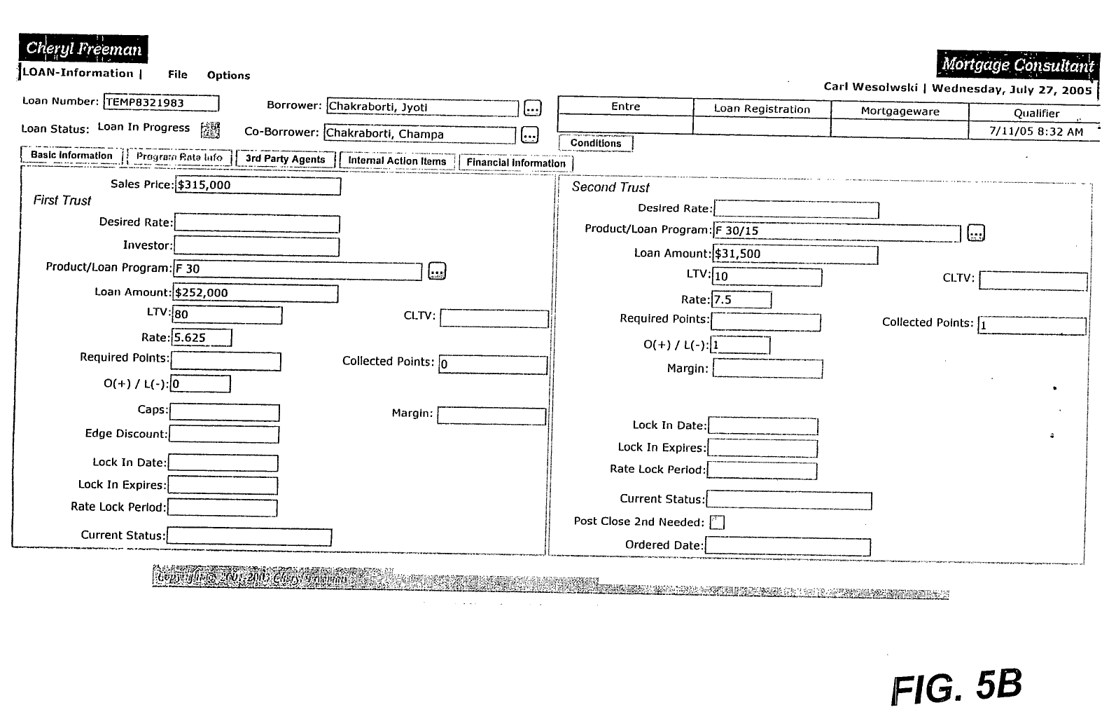

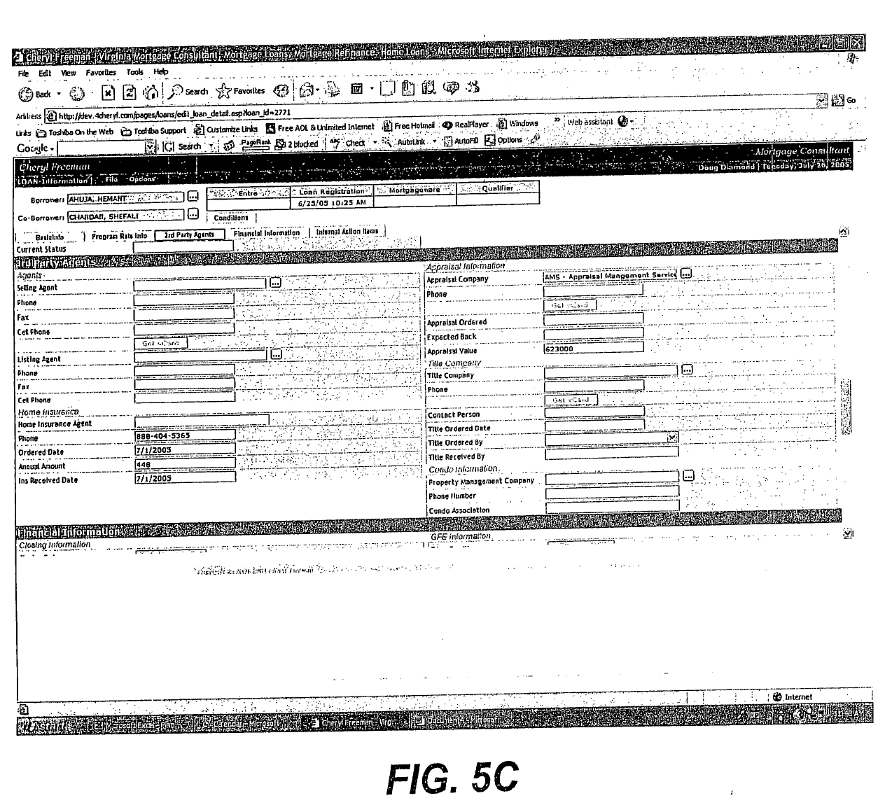

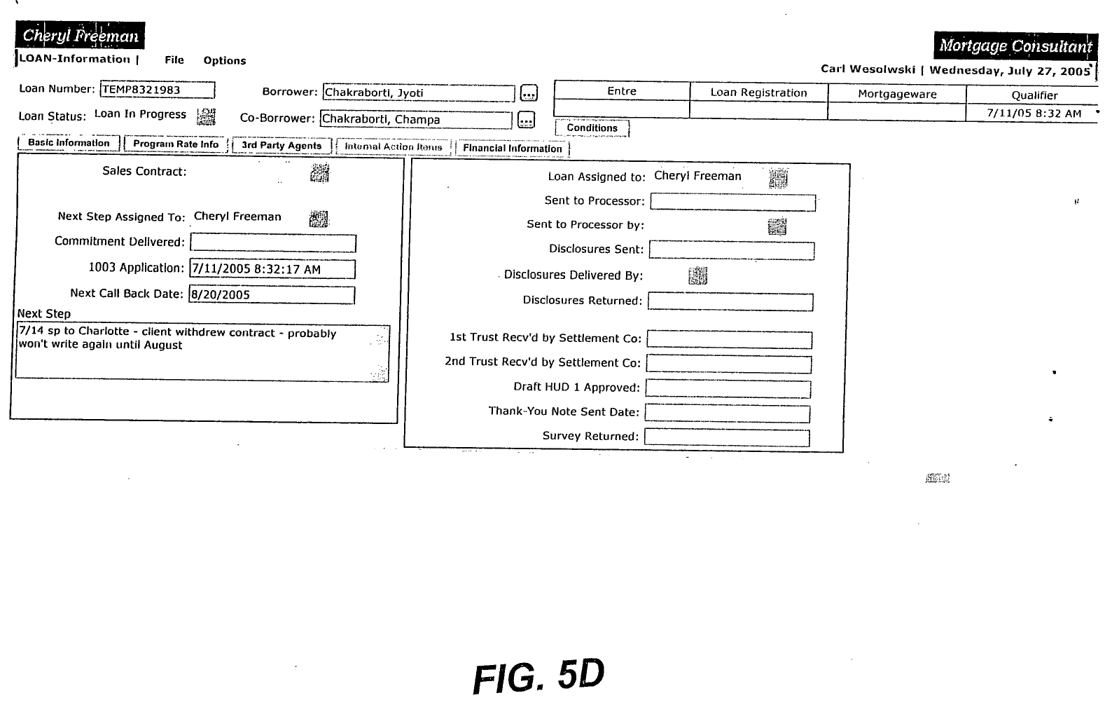

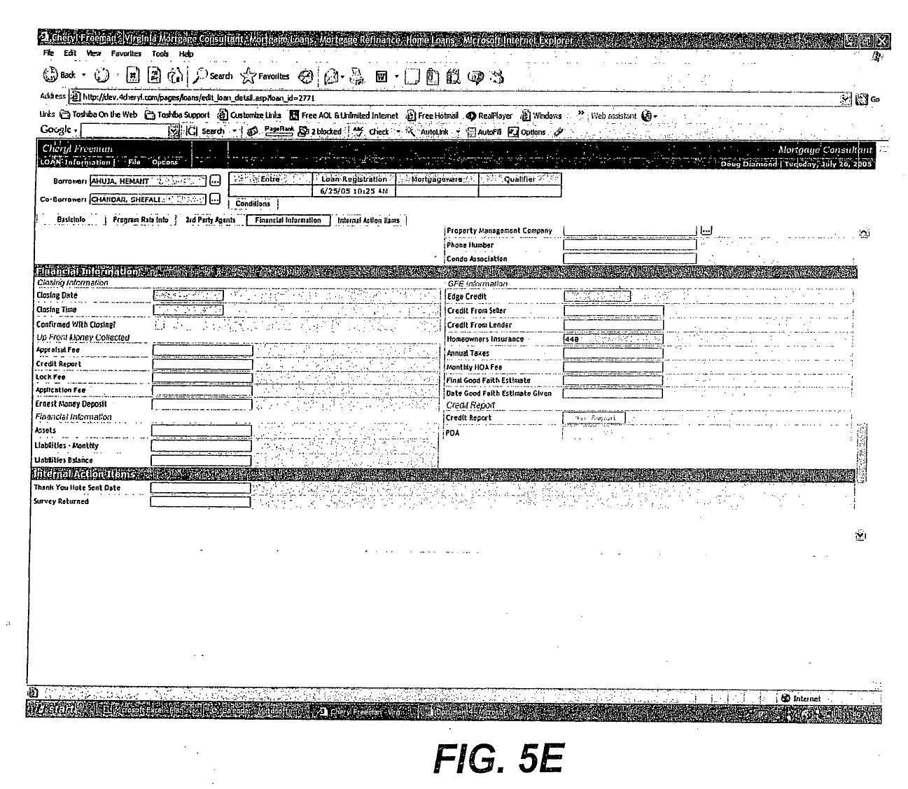

The basic information display area may also include a section 254 containing personal contact information of the borrower and co-borrower, to the extent that one exists. An example of a screen that may be generated by the basic information tab is shown in FIG. 5A.

A program rate information tab 232 provides an indication of how financing is structured for the subject property. When multiple loans (or trusts) are being used to secure financing for purchase of the property, information for the loans is merged and displayed on the same screen. More specifically, as shown in FIG. 4B, the program rate information tab preferably includes an area 260 containing multiple sections, each of which is dedicated to displaying rate and other information associated with each loan required for financing. When only one loan is applied for to secure financing, only one of sections 262 and 264 contains information. When two loans are applied for to secure financing for the property, then both sections are filled in with information stored in the database.

FIG. 5B shows an example of two-loan financing secured for property having a sales price of $315,000. In this scenario, the borrower put 10% down as an initial payment and has chosen to finance $283,500 equal to the remaining balance. The borrower has further chosen to secure two loans to meet this financing requirement, a first trust in the amount of $252,000 at a rate of 5.625% and a second trust in the amount of $31,500 at the rate of 7.5%. When the Program Rate Information tab is selected by a user, the system processor automatically retrieves this information for the two trusts stored in the database record for the property. This information is then displayed side-by-side in area 260. The display of merged trust information for a single property is considered to be an especially advantageous and a novel aspect of the invention, which heretofore has not been available to loan originators on any comparable scale.

In addition to the foregoing features, the information in windows 202, 210, and 220 may be displayed with the program rate information tab for consistency purposes.

An agents tab 233 provides detailed information of third-party agents and/or companies involved in acquiring the property and/or in processing and obtaining final approval of the loan(s). These agents/companies may include, for example, the selling agent, the listing agent, the homeowner's insurance agent, the company which performed or will perform the appraisal, the title company, and the property management company to the extent that one exists. This information may, for example, be set forth in separate fields 271-276 in display area 250 as shown in FIG. 4C, and a more detailed view of the agents tab screen is set forth in FIG. 5C.

An internal action items tab 234 may display information indicating the status information on the sales contract for the property, next-step assignment information, and loan assignment information. (See FIG. 4D). The status information may indicate, for example, whether the contract has been accepted or rejected. The next-step assignment information may identify the mortgage specialist in the loan originator's office responsible for performing next duties in connection with the processing, approval, and/or other management functions associated with the loan(s). The loan assignment information may identify the mortgage specialist managing the loan, along with information indicating whether the one or more trusts used to secure financing for the property has been received by the settlement company, whether HUD approval has been obtained, and even whether thank-you notes have been sent or whether a client survey on performance has been returned. See FIG. 5D for a detailed example of how the fields may be structured to display this additional information.

This status, next-assignment, and loan-assignment information may be displayed in sections 282, 284, and 286 respectively, along with an optional notes section 288 which allows users to type in additional remarks related to one or more of the first three sections. For example, the notes section may include text indicating that the client withdrew or accepted the sales contract. As an alternative, the next-assignment information may be included in the basic information display screen.

A financial information tab may display a listing of assets and/or the aggregate value of assets owned by the borrower and/or co-borrower along with offsetting liability information. See the display area corresponding to section 291 in FIG. 4E. This area may also include a section 292 containing information relating to fee collections, e.g., whether one or more of the appraisal fee, credit report fee, lock fee, and application fee have been collected.

Another section 293 may include GFE information indicative of amounts provided by the seller and borrower, earnest money deposits, annual taxes, monthly HOA fees, good-faith estimates and the date on which the good-faith estimate was given. An additional window 294 may be provided to access credit-report information. A more detailed example of a web page generated when the financial information tab is selected is shown in FIG. 5E.

### Qualifier Sheet

One particularly advantageous feature of the system and method of the present invention is the generation and display of a qualifier sheet. The purpose of this sheet is to include, in a single display, a side-by-side comparison of a plurality of different loan options that may meet the needs of a particular borrower. The sheet may be generated in a variety of ways. For example, the sheet may be generated by importing information on multiple loan options through a network. The information would then be used to populate the fields of a predetermined spread sheet. Alternatively, the information may be imported into the spread sheet based on information stored in memory of the database. As a further alternative, the information may be entered directly into the spread sheet fields by a user, e.g., a mortgage specialist. A combination of these generation methods may also be used.

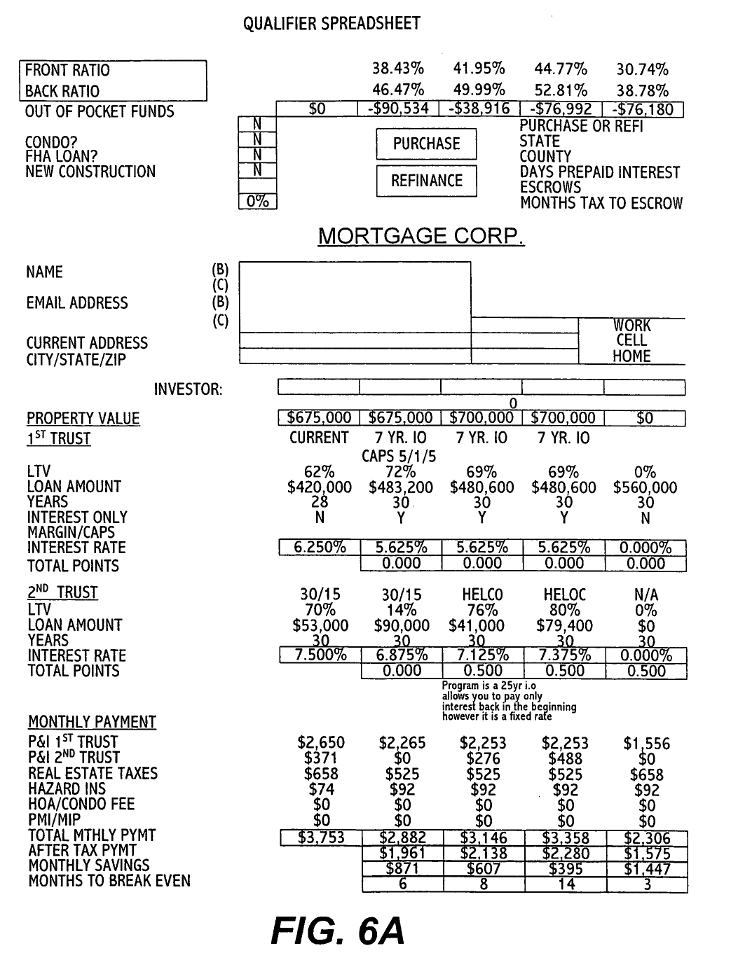

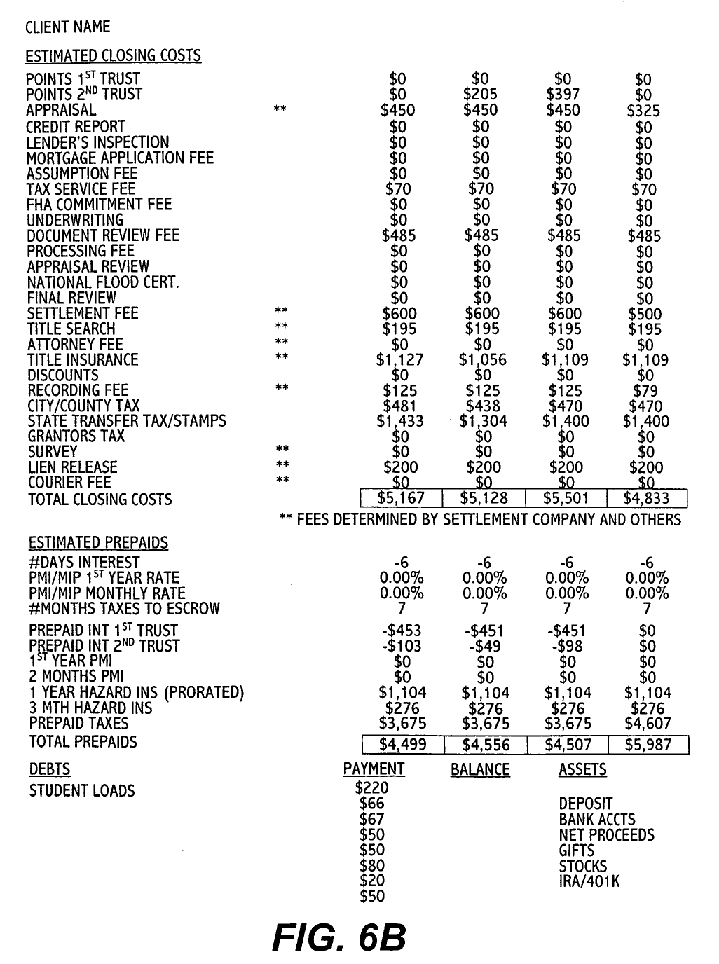

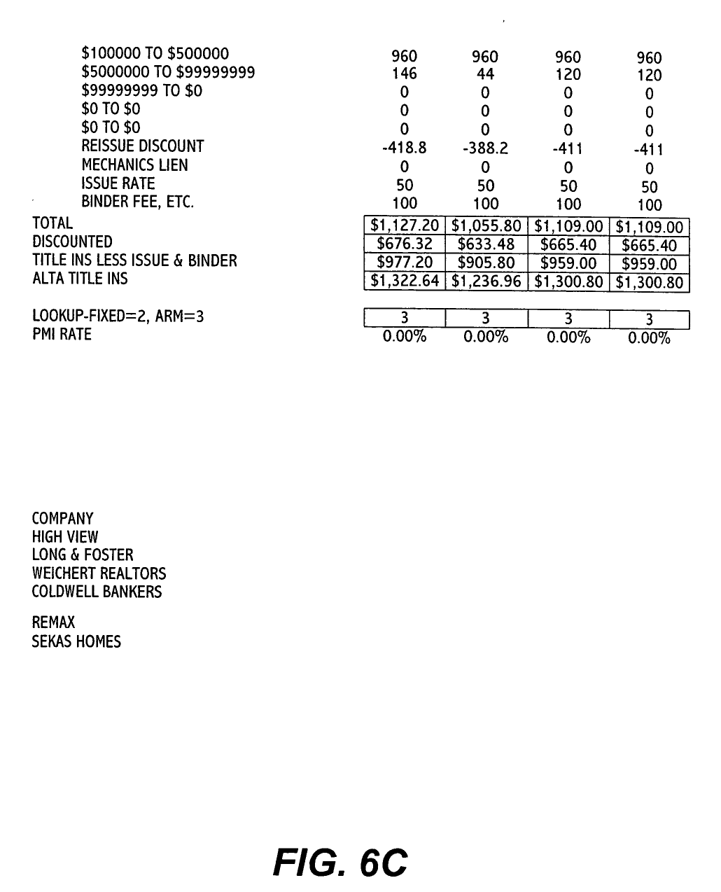

FIG. 6A shows a first page of a qualifier sheet that may be generated in accordance with the present invention. In this sheet, five loan products are compared side-by-side for consideration by a borrower. The first four products are based on the use of first and second trusts to obtain financing for the property. The fifth product proposes the use of one trust, or loan. As shown, a wide disparity exists among the terms and conditions (e.g., interest rates, loan amounts, points, etc.) of the proposed methods of financing. The comparison on this sheet may be used as a marketing tool for providing quotes to prospective client-borrowers, and for helping borrowers more effectively determine what financing arrangements may be best for them based on the products available on the market.

A second page of the qualifier sheet, shown in FIG. 6B, includes a comprehensive listing of all estimated closing costs associated with each product. These costs include point information, credit report fee, appraisal fee, inspection fee, mortgage application fee, and well as other costs. Advantageously, the code used to generate the spreadsheet may be designed to compute these fees based on the local laws and ordinances of each region or state where the property is located. The ability to generate state- or region-specific computations of final closing costs is considered a very desirable feature of the system and method of the present invention and novel in the field.

The second page of the qualifier sheet may also include another section which indicates estimated pre-paid costs. These include PMI costs, escrow and tax payment information, costs associated with the loan(s) proposed to secure financing, hazard insurance premiums, as well as others. The qualifier sheet may also include another section which shows a financial balance sheet for the borrower including his assets and liabilities.

A third page of the qualifier sheet, shown in FIG. 6C, may include an assessment and summary of the total monthly payments that may be required for each loan product, any applicable discounts that may be available, title insurance costs, or other information. Based on these computations, which, for example, may be performed by the system processor executing a relevant software module shown in FIGS. 1A and 1B, the borrower is given the opportunity to determine what loan product may be most suitable from a financial standpoint. Heretofore, there has been no other marketing tool in the field which provides a qualifier sheet of this type.

The date and time the qualifier sheet is created and forwarded to the borrower may be included in qualifier window 224 in FIG. 4A. Also, all relevant supplemental information (e.g., credit reports, appraisal information, etc.) associated with the loan products may be appended to the report, either electronically or through a document scan for transmission to the borrower. This supplemental information may include, for example, a good faith estimate, a truth-in-lending form, and any one of a plurality (e.g., 50) of disclosures selected (or which can selected) based on which loan program the loan officer has chosen for the client.

In addition to the software module that generates and displays the qualifier sheet, software modules may also be included to perform loan initiation (e.g., application) and mortgage underwriting functions. These modules are known and are available, for example, by Harland Financial Solutions under Interlinq MortgageWare and other product names such as Entre; see http://www.harlandfinancialsolutions.com/ProductsAndServices.

As previously discussed, the secondary web pages generated in accordance with the present invention include a loan processing service window which provides an indication of the stage of loan processing a particular loan selected in the first web page may be in at any given time. This window, for example, includes a loan initiation field, a loan registration field, an underwriting field, and a qualifier field. In a typical scenario, the functions associated with each of these fields are performed in series by the loan originator, for example, with the assistance of one or more of the software modules of the system. Alternatively, the date and time information associated with these windows may correspond to a last data import performed in connections with their associated function.

Preferably, these software modules are linked together so that information and data generated by one module (associated with one or more preceding functions of the loan processing procedure) may be automatically imported into another module (associated with performing a succeeding function in the loan processing procedure). As a non-limiting example, information developed by or otherwise obtained during the loan initiation and loan registration functions may be automatically imported into the software module performing the mortgage underwriting function. The system processor may then automatically enter date and timestamp information into the relevant fields of the loan processing service window upon completion of each stage.

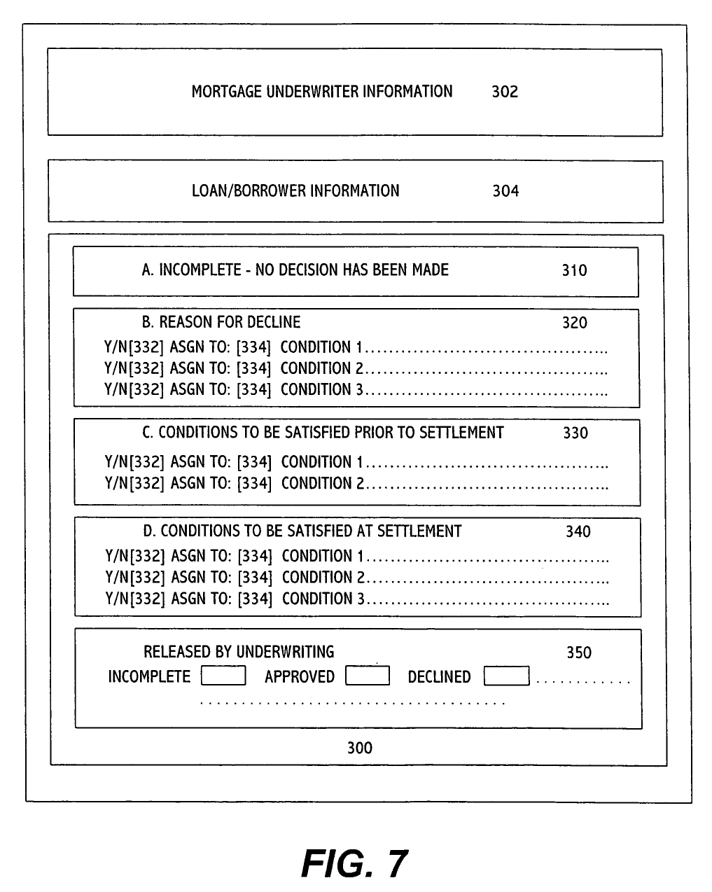

An example of the mortgage underwriting function will now be discussed. When loan registration is completed or at least initiated, the mortgage underwriting program may be implemented based on a link embedded in any of the secondary web pages discussed above or in an associated tool bar. An example of the underwriting program may generate a screen such as shown in FIG. 7.

Using the underwriting program, an image of a conditions sheet 300 may be completed on a screen. This sheet may include a plurality of sections including a mortgage underwriter information section 302, a loan/borrower information section 304, a no decision section 310, a decline section 320, a section 330 specifying conditions to be satisfied before settlement, a section 340 specifying conditions to be satisfied at settlement, and a summary section 350. In each section, additional columns may be provided for each associated condition. These columns may provide, for example, Yes/No boxes 332 indicating whether an associated condition has been satisfied and Assign To boxes 334 indicating the mortgage specialist responsible for completing an associated task. The responsible specialist may be determined by the loan originator or the underwriter, or website software may be included to automatically identify predetermined specialists associated with handling certain conditions. Alternatively, the Assign To box may be associated with a drop-down menu providing a selectable list of specialists.

As a further feature, when a mortgage specialist is identified in box 334, a warning can be shown for a conditions sheet item 312. These warnings may provide an indication of which information or conditions have yet to be performed. The warnings may appear, for example, as highlighted text of a certain color on sheet 300.

Sheet 300 may therefore serve as a conditions checklist which may be used by the underwriter to monitor the status of loan approval. The checklist may also coordinate the handling of loan application approval by the lender.

### Import Function

As previously discussed, one of the desirable features of the present invention is the ability to generate merged trust information such as shown, for example, in the secondary web page of FIG. 4B. The merger and subsequent display of this information may be performed using known software packages that perform import functions. Alternatively, the importation process used to produce this merged information may be performed in accordance with the present invention by software which implements the following steps:
Select import files from different sources each of which may be in a different format (CSV, XML, tab delimited, and Excel), read them, process additional fields and unexpected values, and build a common import data set with this information. This may involve:
   bring data in from a source
   populate temporary customer loans and customer tables
   perform customer matching based on name or other information
   search translation table if imported loan programs match existing loan programs in database, and if so set loan program ID.
   split 1^{st} and 2^{nd} trusts into 2 records.
   match loan programs and title companies to see if there is a match.
Match 1^{st} and 2^{nd} trusts within the import file
   one loan is a first trust, the other is a second trust
   loan numbers are 25 digits apart
   match borrower/co-borrower
   match property address should match
Match 1^{st} and 2^{nd} trusts in the import file to loans on the web site using a score based on matching field values, and determine if an imported loan is a first/second trust based on the loan program on the loan. Loan match criteria may include:
   criteria listed above as already stated
   always match the loans if the Permanent Loan Number matches (but not for a temporary loan number assigned from Entre and Qualifier)
   value's are assigned if each of the following match:
   Borrower Name
   Co-borrower Name
   Property Address
   Closing Date
   Loan Program
   Add loans or update existing loans as appropriate to all relevant fields in the DB.
   Use the first trust loan number as the loan number on the combined loans.
If the score is not high enough, show user the potential loan match. Then, allow user to select if the loan is a match.
Match customers (borrowers and co-borrowers) to the customer table on the web site; add customers when needed, match to existing records as needed, and change or drop a co-borrower as needed.
Use logic that “learns” (e.g., using a knowledge—or rules—based engine) each import using the import's values, and match to the correct ID in the database. Then, edit the table of values and resulting ID's. This may include:
   Add or match selling agents
   Add or match appraisal companies
   Add or match title companies
   Add or match loan programs
Compare the imported loan records to a subset of loans in the database based on the loan status. This may involve, for example, considering only Prospects, Loans In Progress, and Closed loans from the last 30 days of the closing date. The closed loan date may be user definable.
Use field level overwriting logic to determine, based on the import, what information should overwrite other information based on field-by-field weighting. Some fields from Loan Registration may update over Qualifier fields, others may not.
Track the last time that the import was run using fields on the Loan visible at the top of the Loan Details screen.
Entre (Loan Initiation) Import: read through the import file and find the credit report and post that to a separate memo field in the database for display.

In the foregoing steps, when no matches are found for loan programs and title companies, matching may be performed based on user intervention using, for example, a user prompt. This may involve matching values in the import file with ID values in the existing database based, for example, on loan programs, selling agents, appraisal company, and/or title company. Translation tables may be used for each import. Loan officer matching may also be performed. Matched information may be stored in the system for later retrieval. For example, if a name is associated with a particular import source, the system may remember the source in connection that name and perform a retrieval operation automatically for subsequent imports.

Merging the first and second trust information may more specifically involve matching records in a temporary table to existing database information based on weighted values. A new loan record may then be added to the database including the merged first and second trust information, so that a single screen shot may be displayed containing this information as shown, for example, in FIG. 4B. Additional steps include filling in matching loan ID fields and adding a weight field to a temporary table for later reporting. The import loan screen may then be displayed for review.

The following document details the field-by-field priorities for each of the current import sources for purposes of field-level overwriting in accordance with the present invention. Here, the numbers 1, 2, 3, and 4 indicate the priority-overwriting levels where, for example, a “1” should never be overwritten, and “2” would only be overwritten by a “1” and so on.

| | ENTRE | | LOAN REG | | MORTGAGEWARE | | QUALIFIER | |
|---|---|---|---|---|---|---|---|---|
| Borrower Name | | | BORROWER | 2 | BORROWER | 1 | Bname | 4 |
| | | | | | NAME | | | |
| Last | lastname | 3 | | | | | | |
| First | firstname | 3 | | | | | | |
| Middle | middlename | 3 | | | | | | |
| SS# | ss_num | 3 | SSN | 2 | | 1 | | |
| Email | EmailAddress | 3 | EMAIL | 4 | EMAIL | 2 | BEmail | 1 |
| Address | | | ADDRESS | | ADDRESS | | | |
| Nickname | | | | | | | | 1 |
| Customer | CustomerType | | | | | | | |
| Type | | | | | | | | |
| Birthdate | birthdate | 2 | | | BORROWER | 1 | | |
| | | | | | BIRTHDATE | | | |

Borrower Address

| | | | | | | | | |
|---|---|---|---|---|---|---|---|---|
| Street | Currentaddress1 | 3 | STREET | 2 | PROPERTY | 1 | Baddress | 4 |
| | | | | | ADDRESS | | | |
| City | currentcity | 3 | CITY | 2 | CITY | 1 | Bcity | 4 |
| State | currentstate | 3 | STATE | 2 | STATE | 1 | Bstate | 4 |
| ZIP | currentzip | 3 | ZIP | 2 | ZIP | 1 | Bzip | 4 |
| Years In | yearsincurrentlocation | 1 | | | | | | |
| This | | | | | | | | |
| Location | | | | | | | | |

Borrower Phones

| Home | HomePhone | 3 | | | BORRWER | 2 | BHomePhone | 1 |
|---|---|---|---|---|---|---|---|---|
| | | | | | HOME | | | |
| | | | | | PHONE | | | |
| Work | WorkPhone | 3 | | | BORROWER | 2 | BWorkPhone | 1 |
| | | | | | OFFICE | | | |
| | | | | | PHONE | | | |
| Cell | | | | | | | BCellPhone | 1 |
| Marital | maritalstatus | 2 | | | | 1 | | |
| Status | | | | | | | | |
| Employer | Present | 2 | | | | 1 | | |
| | employer | | | | | | | |
| Employer Address | | | | | | 1 | | |
| Street | Present | 2 | | | | 1 | | |
| | Employer | | | | | | | |
| | Address | | | | | | | |
| City | Present | 2 | | | | 1 | | |
| | Employer City | | | | | | | |
| State | Present | 2 | | | | 1 | | |
| | employer State | | | | | | | |
| ZIP | Present | 2 | | | | 1 | | |
| | employer ZIP | | | | | | | |
| Phone | Present | 2 | | | | 1 | | |
| | employer | | | | | | | |
| | Phone | | | | | | | |
| From | Present | 2 | | | | 1 | | |
| | employer from | | | | | | | |
| Years | Present | 2 | | | | 1 | | |
| | employer | | | | | | | |
| | years | | | | | | | |
| Months | Present | 2 | | | | 1 | | |
| | employer | | | | | | | |
| | months | | | | | | | |
| Co-Borrower Name | | 3 | CO- | 2 | CO- | 1 | C name | 4 |
| | | | BORROWER | | BORROWER | | | |
| | | | NAME | | | | | |
| Last | | | | | | | | |
| First | | | | | | | | |
| Middle | | | | | | | | |
| Email Address | | | | | | | C email | 1 |
| Nickname | | | | | | | | 1 |
| Borrower Phones | | | | | | | | |
| Home | | | | | | | C Home | 1 |
| | | | | | | | Phone | |
| Work | | | | | CO- | 2 | C Work | 1 |
| | | | | | BORROWER | | Phone | |
| | | | | | OFFICE | | | |
| | | | | | NUMBER | | | |
| Cell | | | | | | | C Cell | 1 |
| | | | | | | | Phone | |
| Birthdate | | | | | CO- | 1 | | |
| | | | | | BORROWER | | | |
| | | | | | BIRTHDATE | | | |
| Property Address | | | | | | | | |
| Street | Property | 3 | STREET | 2 | PROPERTY | 1 | P address | 4 |
| | address1 | | | | ADDRESS | | | |
| City | Property city | 3 | CITY | 2 | CITY | 1 | P city | 4 |
| State | Property state | 3 | STATE | 2 | STATE | 1 | P state | 4 |
| ZIP | Property postal | 3 | ZIP | 2 | ZIP | 1 | P zip | 4 |
| | code | | | | | | | |
| Property | Property type | 3 | | | PROPERTY | 1 | | |
| Type | | | | | TYPE | | | |
| Purpose | Loan type | 3 | PURPOSE | 2 | TRANSACTION | 1 | Loan Type | |
| (Purch/Refi) | | | | | TYPE | | | |
| Loan # | Pur refi | 3 | LOAN# | 1 | LOAN | 2 | Loan | |
| | | | | | NUMBER | | Number | |
| Status | | | STATUS | 2 | | 1 | | |
| Closing | Closing date | 4 | EST CLOS | 2 | CLOSING | 1 | Est | 3 |
| Date | | | DATE | | DATE | | Closing | |
| | | | | | | | Date | |
| Loan | Loan program | 4 | PROGRAM | 2 | LOAN CODE | 1 | Loan | 3 |
| Program | | | | | | | Program1 | |
| Sales Price | Sales price | 4 | SALES PRICE | 2 | SALES | 1 | Sales | 3 |
| | | | | | PRICE | | Price | |
| Loan | Loan amount | 4 | TOL LOAN | 2 | NOTE | 1 | Loan | 3 |
| Amount | | | AMOUNT | | AMOUNT | | Amount1 | |
| Rate | Rate | 4 | NOTE RATE | 2 | NOTE RATE | 1 | Interest | 3 |
| | | | | | | | Rate | |

| | | | | | | |
|---|---|---|---|---|---|---|
| Collected Points | COLL. PTS. | 2 | COLLECTED | 1 | Points1 | 3 |
| | | | POINTS | | | |
| Required Points | REQ. PTS. | 1 | | | | |
| Lock Date | LOCK DATE | 1 | | | | |
| Expiration Date | EXPIRATION | 1 | | | | |
| | DATE | | | | | |
| LTV | (compute) | 2 | LTV | 1 | LTV1 | 3 |
| CLTV | (compute) | 2 | CLTV | 1 | | |
| Loan Code | | | | | | |
| Edge Credit | EDGE | 1 | | 2 | | 3 |
| | CREDIT | | | | | |
| Margin | MARGIN | 2 | | 1 | | |
| Escrows | ESCROWS | 1 | | | | |
| Caps | CAPS | 2 | | 1 | | |
| Loan Officer | | | | | Loan | 1 |
| | | | | | Assigned | |
| | | | | | To | |

| | |
|---|---|
| Credit | Credit report |
| Report | |

| | | | | |
|---|---|---|---|---|
| Credit Score | CREDIT | 1 | | |
| | SCORE | | | |
| Selling Agent | SELLING | 1 | Selling | 2 |
| | AGENT | | Agent | |
| | NAME | | | |
| Phone | SELLING | 1 | | |
| | AGENT | | | |
| | PHONE | | | |
| | NUMBER | | | |
| Listing | LISTING | 1 | | |
| Agent | AGENT | | | |
| | NAME | | | |
| Phone | LISTING | 1 | | |
| | AGENT | | | |
| | PHONE | | | |
| | NUMBER | | | |

| | | | | |
|---|---|---|---|---|
| Appraisal | Appraisal | 2 | APPRAISED | 1 |
| Value | value | | VALUE | |

| | | | | | | |
|---|---|---|---|---|---|---|
| Appraisal Company | | | APPRAISAL | 1 | | |
| | | | | | COMPANY | |
| Home Insurance Agent | | | | | HOME | 1 |
| | | | | | INSURANCE | |
| | | | | | AGENT | |
| Home Insurance Phone | | | | | HOME | 1 |
| | | | | | INSURANCE | |
| | | | | | AGENT | |
| | | | | | PHONE | |
| Premium | | | | | INSURANCE | 1 |
| | | | | | PREMIUM | |
| Insurance Received Date | | | | | INSURANCE | 1 |
| | | | | | RECEIVED | |
| | | | | | DATE | |
| Second Home | | | | | SECOND | 1 |
| | | | | | HOME | |
| Settlement Co. | SETTLEMENT | 1 | | | | |
| | CO. | | | | | |
| Referred By | | | | | | 1 |

An example of an algorithm that may be used to perform the field level overwriting function is set forth below

### Field Level Overwriting Logic

Has any type of import has already been completed?
   False:
   No imports have been completed. Unconditionally update the database with imported data
   True:
   Determine which import has been run previously for this loan: store in separate Y/N variables (Entre, Qualifier, Loan Reg, Mortgageware) using fields in the DB that track previously run imports
Match data field by field in the import file to the value in the database using the following logic:
For each field in the import file, do the following:
Is the value of the field in the DB null (or empty or the default value-never been updated by a previous import)?
   True:
   Value is empty or null
   Write the field information to the database
   Go on to the next field
   False:
   Valid data from a previous import
Determine the import value's priority from the field priority table. (A lookup table may be used to determine the priority value of each field for each import based on an Excel spreadsheet that defines the field priority table).
Determine the highest priority for that field from the imports that have been run previously.
Is the highest priority for that field from the imports that have been run previously greater than the priority of the field for the current import?
   True (greater than):
   Ignore the imported information for that field. Go on to the next field.
   False (equal to or less than):
   Write the field information to the database
   Go on to the next field

The present invention therefore provides an online mortgage loan application method and system. The system can include the hardware and software that enables a user to access a web site via the user's browser and to use the site to apply for and fund mortgage loans. The system is preferably accessible and usable through at least one of the internet, an intranet, an extranet or other computer network using wire-line, optical, or wireless telecommunications links. In the case of an intranet or extranet, the telecommunications links can be established and maintained by the user for the benefit of the mortgage originators with which it does business.

The system is preferably implemented with the use of a dynamic, interactive web site that includes a data base and enabling software. The site may be linked via the use of hypertext markup language and world wide web protocols internally and externally to other web sites so that the user can navigate through the site to find information and access its various features and information available at other sites. The user interface described herein can include web pages running on the user's browser, which is preferably a current version of any of the most commonly used internet browsers.

Once having logged onto the secure portion of the web site, a user can access screens or windows that includes various “buttons”, “pop up” windows and “pull down” menus that the permit the user to navigate the site and both provide and obtain information. The basic technology that is used in creating and operating web sites-databases, web site programming languages, object-based programming, “buttons”, “pop up windows”, “dialog boxes”, navigation bars, and the well known operations required to operate a computer programmed with object-based programming—clicking, pointing and entering data in dialog boxes—, are not part of embodiments of the invention and are all well known. Rather, the embodiments of the invention can include how this technology is employed, the combinations of features, the type of information and features selected for inclusion in the combination, and the site informational and graphic architecture.

In accordance with other embodiments, the system and method of the present invention may automatically access from the database and display information relating to a client's (e.g., borrower's) loan when the client logs in to the one or more of the web pages discussed herein. This information may include principal, interest rate, status, and/or other loan-related information.

Additionally, when a client logs on, the system and method of the present invention may automatically display a message requesting information or verification of information required or otherwise considered of interest in acquiring or otherwise managing the client's loan. The client may respond, for example, by entering this information into fields provided on the screen, by sending a reply e-mail to a specified address, or any number of other ways.

In accordance with another embodiment, any one or more of the web pages discussed herein may include a marketing tab which tracks information relating to or otherwise of interest to selling agents or clients of the loan originator sponsoring the web pages. This information may summarize the historical performance of the selling agents and/or clients as well as their responsiveness. Examples include the number of referrals received from selling agents, the total dollar volume of those referrals, and the percentage of loans that closed for those agents. The marketing tab may also provide information which tracks activities of the referral sources including, for example, the number of invitations extended to selling agents or other personnel by the loan originator and the number of times those invitations were accepted (e.g., the number of times the selling agents actually attended social- or business-related meetings, receptions, events, or other activities).

In accordance with another embodiment, any one or more of the web pages discussed herein may generate and display pre-printed forms to be filled out by clients during the loan application process. These forms may include a 10-03 Form as well as other state or federally required forms. Clients may fill in these forms out on-line, for example, by entering information in respective form fields. The filled-out forms may then be stored in the system database when, for example, a Submit icon associated with the form is clicked on. Alternatively, information on the forms may be manually entered into the database by a mortgage specialist.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order-dependent in their performance. That is, some procedures may be able to be performed in an alternative ordering, simultaneously, etc.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

I claim:

1. An interactive information management system, comprising:
a communications port;
a database to store mortgage information;
a processor, coupled to the communications port, to generate an electronic qualifier sheet based on information received through the communications port, said qualifier sheet providing a comparison between different loan products available to a borrower seeking to secure financing for a property.

2. The system of claim 1, wherein the processor executes an import function to receive information on said different loan products from different external sources.

3. The system of claim 2, wherein the processor converts the loan information imported from different sources into a common format for display in the qualifier sheet.

4. The system of claim 1, wherein the qualifier sheet includes a comparison of rates, monthly payments, estimated closing costs, and property taxes for the property in accordance with terms and conditions of each of the loan products.
